(19) United States
(12) Patent Application Publication
(10) Pub. No.: US 2022/0361460 A1
(43) Pub. Date: Nov. 17, 2022

(54) Organism Monitoring Devices and Organism Monitoring Methods

(71) Applicant: Battelle Memorial Institute, Richland, WA (US)

(72) Inventors: Z. Daniel Deng, Richland, WA (US); Jun Lu, Richland, WA (US); Huidong Li, Richland, WA (US); Jayson J. Martinez, Kennewick, WA (US)

(73) Assignee: Battelle Memorial Institute, Richland, WA (US)

(21) Appl. No.: 17/322,287

(22) Filed: May 17, 2021

(51) Int. Cl. A01K 61/90; G01S 1/72; G08C 23/02

(52) U.S. Cl. CPC A01K 61/90; G01S 1/725; G08C 23/02

(57) ABSTRACT

Organism monitoring systems and devices and associated monitoring methods are described. According to one aspect, an organism monitoring device configured to be associated with an organism to be monitored includes a housing, a battery coupled with the housing, wherein the battery is configured to store electrical energy, a transmitter coupled with the housing and the battery, wherein the transmitter is configured to emit a wireless signal externally of the organism monitoring device and the organism being monitored, sensor circuitry coupled with the housing and the battery, wherein the sensor circuitry is configured to monitor an environment of the organism monitoring device, and control circuitry coupled with the housing, the sensor circuitry and the battery, and wherein the control circuitry is configured to adjust an operation of the organism monitoring device as a result of monitoring of the environment of the organism monitoring device by the sensor circuitry.

### STATEMENT AS TO RIGHTS TO INVENTIONS MADE UNDER FEDERALLY-SPONSORED RESEARCH AND DEVELOPMENT

This invention was made with Government support under Contract DE-AC05-76RL01830 awarded by the U.S. Department of Energy. The Government has certain rights in the invention.

### TECHNICAL FIELD

This disclosure relates to organism monitoring devices and organism monitoring methods.

### BACKGROUND OF THE DISCLOSURE

Acoustic telemetry has been initially used in fisheries research to study fish behavior and more recently for estimating fish survival. Improvements in acoustic telemetry have helped researchers and managers better understand the behavior of fish, mitigation issues and identify potential issues that result in reduced survival of fish in lakes, reservoirs or rivers as well as passage of fish at dams.

Acoustic telemetry systems operate by monitoring specimens that have been tagged with an acoustic fish tag. A choice between the service life and the physical size of an acoustic fish tag has always been a conundrum for tag users.

In particular, it is typically desired that the acoustic fish tags last for as long as possible to obtain information on the fish behavior over a long period of time or multiple stages of the fish's life cycle. Larger batteries are typically utilized to provide longer periods of operation of the tags where longer service life is desired. This is usually not an issue when monitoring larger species of fish.

However, use of acoustic fish tags is particularly a challenge for tracking fish species that are small or have long and flexible bodies as these animals require use of tags of reduced size. Accordingly, the tags utilized for monitoring smaller species are relatively small and light to minimize the burden or impact of the tags on the specimens being monitored and to provide study results that are not biased by the tags. Accordingly, these tags use relatively small batteries with reduced storage energy capacities that limit the service lives of the smaller tags compared to larger tags.

At least some aspects of the disclosure are directed to improved apparatus and methods for monitoring organisms in their environments including controlling amounts of electrical energy consumed during the monitoring. Additional aspects are discussed below.

### BRIEF DESCRIPTION OF THE DRAWINGS

Example embodiments of the disclosure are described below with reference to the following accompanying drawings.

FIG. 1 is an illustrative representation of an aquatic organism monitoring system according to one embodiment.

FIGS. 2A and 2B are respective top and bottom perspective views of an organism monitoring device according to one embodiment.

FIGS. 3A and 3B are illustrative representations of opposing sides of a circuit board and components thereon according to one embodiment.

FIG. 4 is a functional block diagram of components of a monitoring device according to one embodiment.

FIG. 5 is an illustrative representation of a salinity sensor according to one embodiment.

FIG. 6 is a graphical representation of output voltage of a salinity sensor with respect to time according to one embodiment.

FIG. 7 is a schematic diagram of circuitry of a monitoring device according to one embodiment.

### DETAILED DESCRIPTION OF THE DISCLOSURE

This disclosure is submitted in furtherance of the constitutional purposes of the U.S. Patent Laws “to promote the progress of science and useful arts” (Article 1, Section 8).

Example embodiments discussed herein are directed to monitoring systems that are capable of monitoring organisms in their environments and associated methods of operation of the systems. More specific embodiments of the monitoring systems and methods include monitoring aquatic organisms within an aquatic environment. The monitoring systems include organism monitoring devices that may be referred to as tags and are associated with respective organisms to be monitored as they move throughout their environment. Any suitable method and apparatus may be used to attach the monitoring devices to the organisms to be monitored, including surgical implantation or use of sutures depending upon the species of organisms to be monitored in illustrative examples.

The organism monitoring devices are configured to emit wireless signals externally of the devices and the associated organisms, and into the environment about the organisms. In some embodiments, the organisms being monitored are aquatic organisms within an aquatic environment. The emitted wireless signals may be received by one or more receivers of the monitoring system. A plurality of receivers may be placed at different locations of the environment of the organisms to monitor the locations of the tagged organisms as they move throughout their environment. The emitted wireless signals may be acoustic signals in some embodiments although other types of wireless signals, such as electromagnetic signals, may be emitted in other embodiments.

In some organism monitoring applications, it is not necessary for the monitoring devices of the monitoring system to continuously transmit the wireless signals until their batteries are completely drained and which result in reduced service lives of the monitoring devices. In some embodiments of the monitoring systems discussed herein, the monitoring devices are configured to monitor the environment about the monitored organisms (and the respective monitoring devices) and to adjust the amount of electrical energy that is consumed by the monitoring devices as a result of the monitoring of the environment. Some illustrative examples of different monitorings of the environment to control power consumption of the devices discussed below include monitoring for the presence of electromagnetic energy within the environment and monitoring salinity of the water in an aquatic environment. Other aspects of the environment may be monitored for use in controlling power consumption of the monitoring devices in other implementations of the monitoring systems.

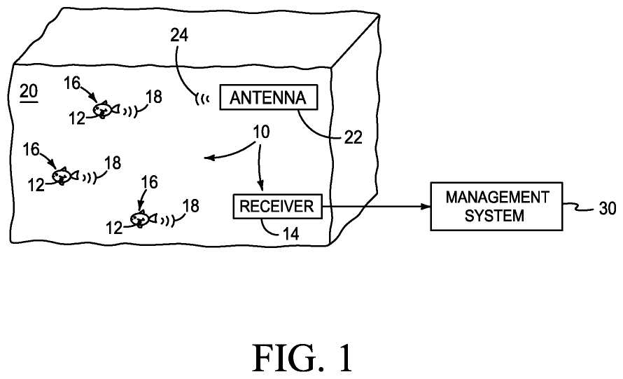

Referring to FIG. 1, one example embodiment of a monitoring system 10 is shown. The illustrated system 10 includes a plurality of organism monitoring devices 12 that are associated with a plurality of aquatic organisms 16, such as fish, to be monitored. The organisms 16 having associated devices 12 may be referred to as tagged organisms.

The depicted system 10 further includes a receiver 14 within an aquatic environment 20, such as fresh, salt or brackish water, and a management system 30. Monitoring devices 12 emit a plurality of wireless signals 18 at a plurality of moments in time (e.g., periodic) that propagate through the environment 20 and are received by receiver 14. Although not shown, the system 10 typically includes a plurality of receivers 14 that are positioned at different locations within the body of water of the environment 20 to receive the wireless signals 18 at the respective different locations as the organisms 16 move throughout the body of water 20. Example wireless signals 18 include acoustic signals generated by piezoelectric transducers (PZT) of the monitoring devices 12 in illustrative embodiments discussed further below.

The emitted wireless signals 18 enable tracking or monitoring of the organisms as the organisms move throughout their natural environment in some embodiments. The monitoring devices 12 may each include a unique respective identification (ID) code within its emitted wireless signals 18 to enable tracking of individual unique organisms 16. The locations of the individual tagged organisms 16 may be generally monitored by management system 30 using the identification codes and the locations of the receivers 14 that received the respective wireless signals 18 including the identification codes. In addition, times of arrival of wireless signals 18 at a plurality of receivers 14 located at different locations of the environment may be captured and used to triangulate the locations of the organisms 16 with increased accuracy.

Management system 30 is configured to receive information included in the wireless signals 18 from devices 12 that are associated with respective organisms 16 from one or more receivers 14. In illustrative examples, information of the wireless signals 18 (e.g., identification codes) that are emitted from the monitoring devices 12 and received by receiver 14 is communicated to the management system 30 for data storage and to use in study of the tagged or monitored organisms 16, such as migratory patterns.

One or more antennas 22 may also be present in the aquatic environment and configured to emit wireless signals 24 that may be received by the monitoring devices 12 in the vicinity of the antennas 22. In one implementation, an antenna 22 emits a constant electromagnetic (EM) field at a selected radio frequency (RF). In one embodiment, the emitted electromagnetic energy may include one or more codes that may be received by the monitoring devices 12. In one more specific implementation, the antenna 22 emits the wireless signals 24 that interact with Passive Integrated Transponders (PITs) that may be embedded within fish also within the environment in the vicinity of the antenna 22. The antennas 22 that emit electromagnetic energy to detect Passive Integrated Transponders are installed in the water near large hydropower facilities in the United States, such as along fish ladders or fish bypasses. The emitted electromagnetic energy from the antennas 22 may be received and monitored by sensor circuitry of the monitoring devices 12.

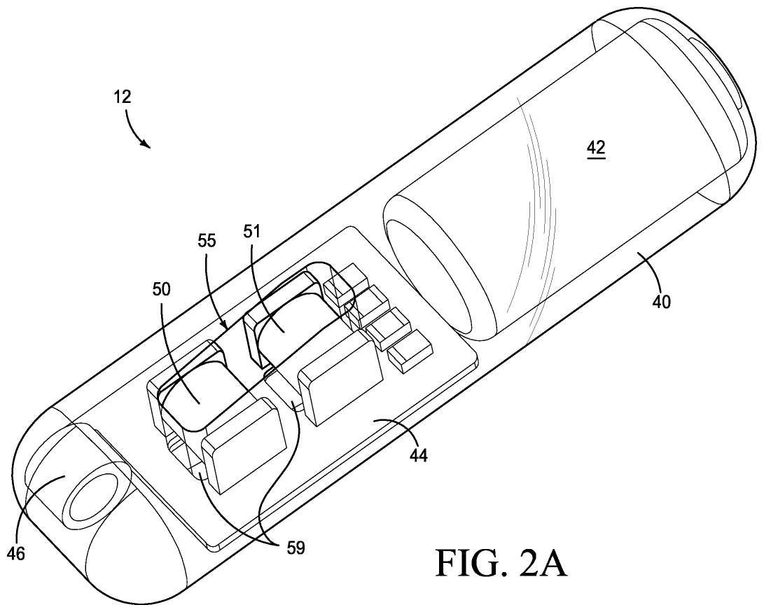

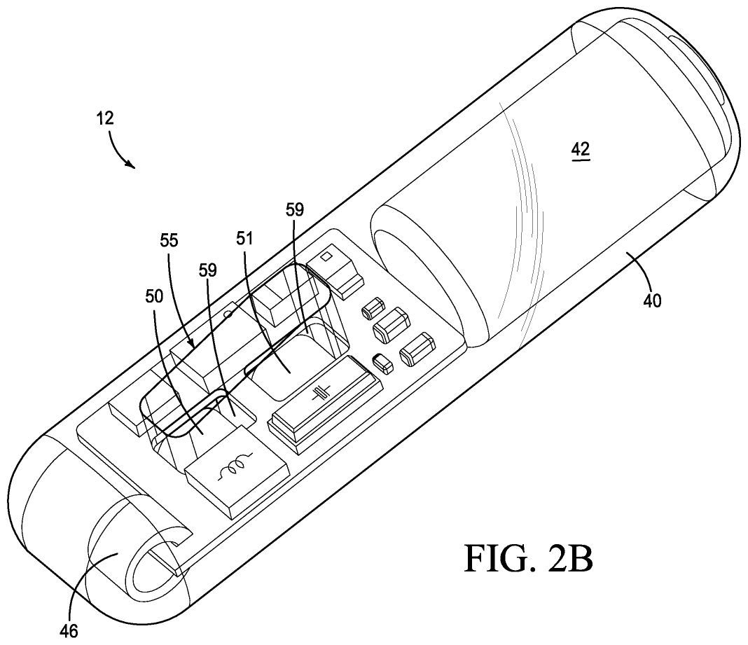

Referring to FIGS. 2A and 2B, respective top and bottom perspective views of one embodiment of monitoring device 12 are shown. The illustrated monitoring device 12 includes a housing 40, a battery 42, a printed circuit board 44, and a transmitter 46. The monitoring devices 12 discussed herein may be fabricated using small footprint, high-performance, low-power operation, and commercially-available electronic components in some embodiments. A plurality of circuit components may be attached to printed circuit board 44 as discussed below. Other arrangements of monitoring device 12 apart from the configuration shown in FIG. 2 are possible.

At least some of the components of the monitoring device 12 are encapsulated in a suitable epoxy that forms housing 40.

The printed circuit board 44 includes plural inductive coils 50, 51 mounted thereon and which are components of sensor circuitry discussed below. The housing 40 includes an aperture 55 that extends through the entirety of the monitoring device 12 from the top to the bottom. In addition, printed circuit board 44 includes apertures 59 that are aligned with aperture 55. Apertures 55, 59 are exposed to the aquatic environment and permit water from the environment to enter into a compartment that includes coils 50, 51 and that allows the coils 50, 51 to be exposed to the water of the environment and monitor or sense the salinity of the water as discussed further below. The other components of the monitoring device 12 apart from the coils 50, 51 are sealed and isolated from the environment.

Transmitter 46 is configured to emit the wireless signals externally of the monitoring device 12 and associated organism. In one embodiment mentioned above, transmitter 46 is a piezoelectric transducer (PZT) that is configured to emit acoustic signals from the monitoring device 12 although other transmitters may be used in other embodiments.

In some embodiments, the monitoring device 12 has a weight less than 0.85 g in air, a width less than 7 mm and a length less than 25 mm. In the embodiment illustrated in FIG. 2, the monitoring device has a weight of 0.84 g, a width of 6.5 mm and a length of 24.25 mm. Further reductions in size and weight are achieved by using smaller components, such as a battery with a smaller capacity.

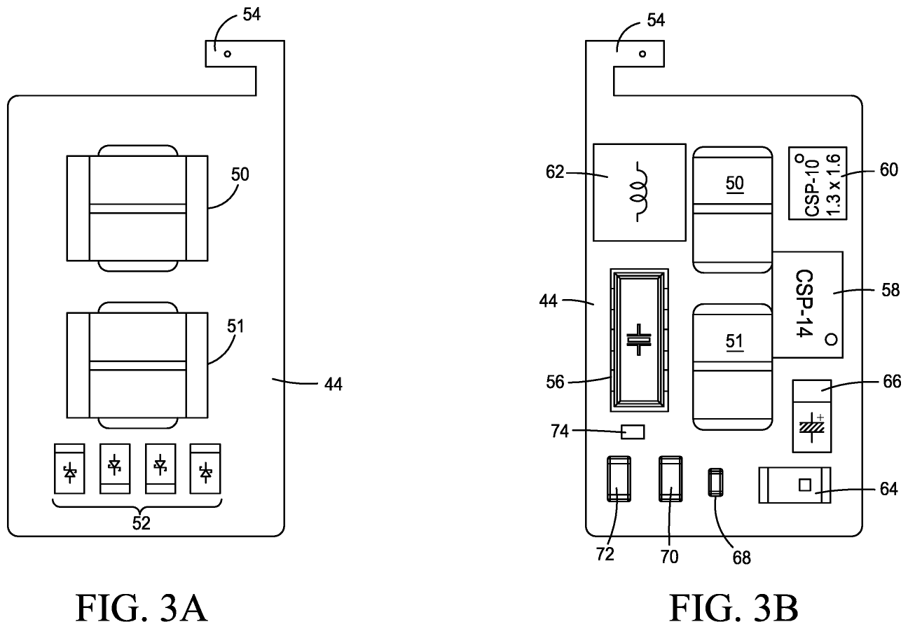

Referring to FIGS. 3A and 3B, respective opposing first and second sides of an example circuit board 44 and circuit components thereon are shown according to one embodiment. The circuit components adjacent to the first side of the circuit board 44 shown in FIG. 3A include plural inductive coils 50, 51 and a plurality of diodes 52. The circuit components adjacent to the second side of the circuit board 44 shown in FIG. 3B include a resonator 56, microcontroller 58, dual analog switch 60, inductor 62, infrared sensor (e.g., phototransistor) 64, capacitor 66, resistors 68, 72, 74, and a capacitor 70.

The illustrated circuit board 44 additionally includes an arm 54 that extends outwardly from the main portion of the board 44 and is received within an interior portion of the transmitter 46 (transmitter 46 is not shown in FIGS. 3A and 3B). Example operations of the circuit components of the illustrated embodiment of the monitoring device 12 are discussed below.

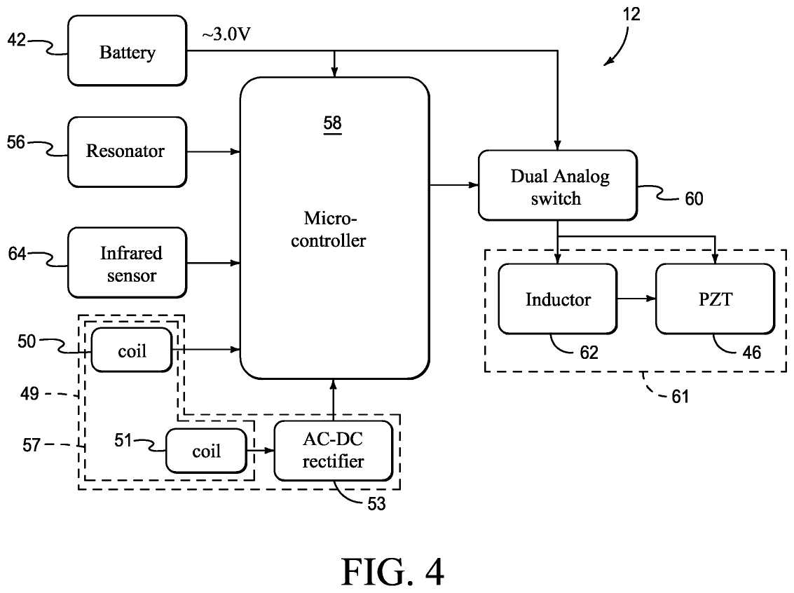

Referring to FIG. 4, a functional block diagram of a monitoring device 12 is shown according to one embodiment. Other embodiments of monitoring device 12 are possible including more, less and/or alternative components.

Battery 42 is configured to store and output electrical energy of approximately 3V to appropriate circuit components of the monitoring device in one illustrative example.

Microcontroller 58 is one example of control circuitry that may be utilized to process information and control operations of the monitoring device including implementing monitoring operations and controlling of power consumption. In one more specific embodiment, microcontroller 58 is configured to control an adjustment of an amount of electrical energy of the battery 42 that is consumed by the organism monitoring device 12 as a result of the monitoring of the environment by sensor circuitry of the device as described further below.

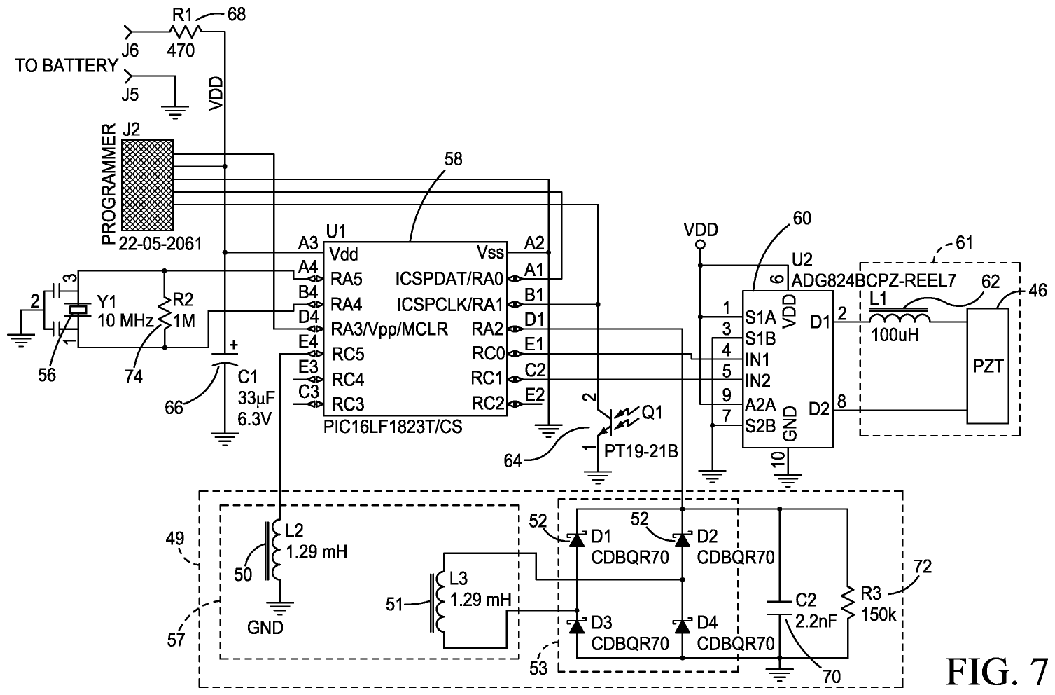

Resonator 56 is a ceramic resonator in the disclosed embodiment and is configured to output a 10 MHz clock signal to control timing of the monitoring device 12. The resonator 56 and 1 MOhm resistor shown in FIG. 7 enable the monitoring device 12 to generate wireless signals at a frequency of 416.7 kHz in one example embodiment and other signals of other frequencies may be used in other embodiments.

Infrared sensor 64 receives configuration commands through an optical link and transfers the commands to microcontroller 58. Example commands include activating the monitoring device 12 or changing the pulse rate interval (PRI) of the monitoring device 12.

As mentioned above, monitoring device 12 utilizes acoustic waves for underwater wireless communication according to some embodiments of the disclosure. Dual analog switch 60 alternately switches application of the battery voltage to two sides of a signal generation sub-circuit 61 that includes an inductor 62 and transmitter 46. The transmitter 46 outputs a wireless signal in the form of an acoustic signal or transmission that is emitted externally of the monitoring device and associated organism into the aquatic environment as a result of the applied electrical energy from the battery 42. An example acoustic transmission has a signal level of approximately 156 dB at 3 volts and that consumes about 30 uJ energy.

In one embodiment, transmitter 46 is a piezoelectric tube that is driven by a drive circuit including resonator 56, microcontroller 58, dual analog switch 60 and inductor 62. The dimensions and geometry of the described transmitter 46 were designed to achieve a resonance frequency of 416.7 kHz, which is beyond the background noise in turbulent aquatic environments, and to achieve an omnidirectional acoustic beam pattern.

During operation, the microcontroller 58 outputs a binary phase-shift keying (BPSK) encoded waveform through analog switch 60 onto either side of the signal generation sub-circuit 61 to generate the wireless signals. A wireless signal transmission includes a 31-bit hexadecimal value comprising a 7-bit Barker code, a 16-bit payload including information or data, and an 8-bit cyclic redundancy check (CRC) code in one embodiment.

The series inductor 62 is coupled with one electrode of the transmitter 46 and establishes a resonance with the fundamental capacitance thereof. As a result, a much higher effective driving voltage is achieved, leading to stronger signal strength and a longer transmission distance.

Additional details regarding operations of the circuit components of the embodiment of monitoring device 12 shown in FIG. 4 are discussed in a U.S. patent application Ser. No. 16/951,251, filed Nov. 18, 2020, titled “Aquatic Organism Monitoring Devices and Aquatic Organism Monitoring Methods”, having attorney docket number 31774-E US (BA4-0830), and the teachings of which are incorporated herein by reference.

The illustrated monitoring device also includes sensor circuitry 49 that is configured to monitor an environment about the organism monitoring device 12. In one embodiment, the sensor circuitry 49 provides outputs to microcontroller 58 as a result of monitoring an environment about the monitoring device 12. The microcontroller 58 processes the outputs and adjusts an operation of the monitoring device 12 as a result of the monitoring of the environment by the sensor circuitry 49 and processing of the outputs therefrom.

In some example embodiments discussed below, the microcontroller 58 adjusts an operation of the monitoring device 12 that adjusts an amount of the electrical energy of the battery 40 that is consumed by the monitoring device 12 at different moments in time.

In other embodiments, the microcontroller 58 changes a code that is communicated in wireless signals as a result of the monitoring of the environment. More specifically, the emitted wireless signals may initially include a first unique code while subsequently emitted wireless signals include a second unique code that is different from the first unique code.

In illustrative examples discussed further below, the sensor circuitry 49 is configured to monitor for the presence of electromagnetic energy in the aquatic environment of the organism being monitored and the salinity of water of the aquatic environment. Microcontroller 58 is configured to control an adjustment of an amount of electrical energy that is consumed by the monitoring device 12 as a result of the sensor circuitry detecting the presence of the electromagnetic energy in the aquatic environment according to one example aspect. In some embodiments, the control circuitry is configured to control the adjustment of the amount of the electrical energy as the result of the monitoring detecting a code in the electromagnetic energy as discussed further below. Microcontroller 58 is configured to control the adjustment of electrical energy consumption as a result of the monitoring of the salinity of the aquatic environment by the sensor circuitry 49 according to an additional example aspect discussed below.

Still referring to FIG. 4, the illustrated sensor circuitry 49 includes first and second inductive coils 50, 51. In one embodiment, coil 51 is configured to generate a current in the presence of electromagnetic energy in the environment of the monitoring device 12. As mentioned above, some of the large hydropower facilities in the United States have Passive Integrated Transponders (PIT). PIT antennas emit a constant electromagnetic (EM) field at a radio frequency (RF) that is received by coil 51 when the organism with the associated monitoring device moves within range of the emitted electromagnetic field.

The received electromagnetic field induces a current within coil 51 and an output AC voltage is applied to AC-DC rectifier 53. In one embodiment, rectifier 53 includes four Schottky barrier diodes with low forward voltage that convert the AC output voltage from coil 51 to a DC voltage. As discussed below, the DC voltage may charge a capacitor (e.g., shown as capacitor 70 in the example embodiment of FIG. 7) that in turn outputs a voltage to microcontroller 58.

Microcontroller 58 monitors an output voltage of the AC-DC rectifier 53 and capacitor. The microcontroller 58 is configured to detect the presence of the electromagnetic field within the aquatic environment of the monitoring device as a result of the capacitor voltage exceeding a threshold voltage. In some embodiments, microcontroller 58 may be operating a given power consumption state (e.g., hibernation state or full power state) and the presence of the output voltage from rectifier 53 triggers an interrupt within the microcontroller 58 to change operations of the microcontroller 58 to a different state or mode of power consumption.

In one more specific example, microcontroller 58 is configured to enter a second state of increased power consumption from a first state of reduced power consumption as a result of the microcontroller 58 receiving the interrupt from the sensor circuitry 49. During operation in the state of increased power consumption, microcontroller 58 processes outputs of the sensor circuitry 49 (e.g., codes within the electromagnetic energy received by the sensor circuitry 49 as discussed below) and controls appropriate action such as increasing or decreasing an amount of the electrical energy that is consumed by the monitoring device 12 as a result of the processing of the codes.

In another embodiment, microcontroller 58 may control the amount of electrical energy utilized by one or more components of the monitoring device 12, for example, by powering on or off the one or more components as a result of the received interrupt. Additional examples of controlling the consumption of electrical energy by the monitoring device 12 are discussed further below.

The above-described example of use of electromagnetic energy from a PIT antenna is one example source of monitored electromagnetic energy. Electromagnetic energy from transmitters or sources other than a PIT antenna may be received by the monitoring device 12 and used to initiate adjustment of the power consumption of the monitoring device in other embodiments.

The electromagnetic energy that is received by the monitoring device 12 may include one of a plurality of different codes that may be processed by the microcontroller 58. The codes may be generated by RF modulation of the electromagnetic energy (e.g., from a PIT antenna) in one embodiment. The codes may be used by the microcontroller 58 to control the amount of electrical energy consumed by the monitoring device either upwards or downwards. The codes may also be used to reduce false triggering resulting from other spurious electromagnetic energy in the aquatic environment from other sources that do not have the appropriate codes.

In some embodiments, different PIT antennas at different locations in an aquatic environment may emit electromagnetic energy having respective unique codes that may be processed by the microcontroller 58 to identify the particular source of the electromagnetic emission (e.g., a PIT antenna from a specific hydropower location). The detection of a unique code from a source at a known location may also be used to provide information regarding the location of the monitoring device 12 in its environment at a moment in time when the code was received.

In one embodiment, microcontroller 58 is configured to select one of a plurality of different power consumption control operations as a result of and corresponding to the unique code detected within the received electromagnetic energy. For example, the microcontroller may provide the monitoring device 12 in a state or mode of increased power consumption as a result of the reception of a binary code of 101 and the microcontroller may provide the monitoring device 12 in a state or mode of decreased power consumption as a result of the reception of a binary code of 010 in one illustrative example. Accordingly, the microcontroller 58 is programmed to perform different operations in response to detection of different codes in received electromagnetic energy in some implementations.

This example use of codes allows a monitoring device 12 to recognize the specific hydropower location which it is currently located at and enable/disable its functions accordingly to either increase or decrease the consumption of electrical energy. This feature can be particularly useful for monitoring anadromous fish species. Such a monitoring device implanted in an anadromous fish before it migrates out to the ocean could be programmed to go into a low power consumption state (e.g., hibernate) upon detection at a specific hydropower location and during the long period when the fish is in the ocean where no detection equipment is deployed and hence there is no need for transmissions. Upon the fish's return from the ocean as it passes through the dams equipped with these PIT antennas, the tag would be able to automatically resume operation or even enable different functions at different dams if necessary by use of the codes.

The sensor circuitry 49 also includes a coil 50 in addition to coil 51 as mentioned above. The combination of coils 50, 51 forms a salinity sensor 57 in some embodiments that is configured to monitor the salinity of the water of the aquatic environment and to generate a current that is proportional to the salinity of the water of the aquatic environment.

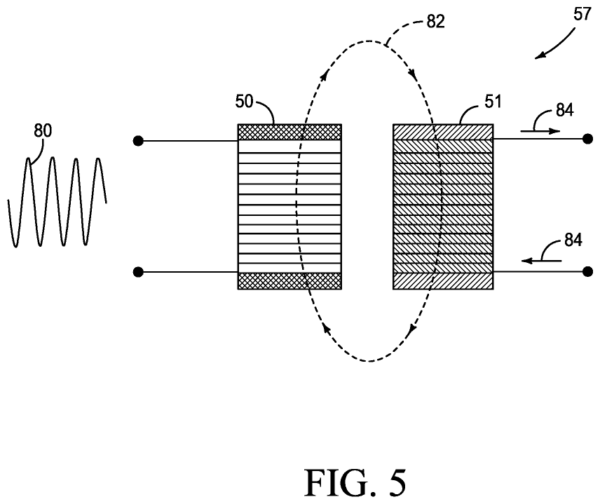

Referring to FIG. 5, one embodiment of salinity sensor 57 is shown in the form of an inductive sensor including coil 51 discussed above as well as coil 50 that may be referred to as a driving coil. The depicted salinity sensor 57 is essentially a conductivity sensor as it measures the conductivity of the water which is then correlated to the salinity. The two inductive coils 50, 51 are positioned closely next to each other (e.g., 3 mm apart) and are used as a current transformer with coil 50 operating as the driving coil as discussed above and the coil 51 operating as the receiving coil. As the two coils 50, 51 are submerged into a liquid medium, a closed conductive path is formed around them.

In one embodiment, the microcontroller controls the application of electrical energy to the coil 50 to induce a magnetic field to enable monitoring of the salinity of the water periodically (e.g., once per minute). In one more specific embodiment, the microcontroller controls the output of an AC voltage 80 to inductive coil 50. When AC voltage 80 is applied to inductive coil 50, an electromagnetic field 82 is induced that excites the receiving inductive coil 51 and an induced current 84 flows from the coil 51 to the rectifier (the rectifier is not shown in FIG. 5 but the rectifier receives the induced current 84 from the sensor 57). The value of the current 84 is proportional to the ion concentration of the liquid medium (i.e., salinity in water). In water, as the salinity increases, the induced current 84 within the receiving coil also increases. In one embodiment, the induced current 84 is used to charge a capacitor 70 of sensor circuitry 49 shown in the circuitry FIG. 7.

As mentioned above, the microcontroller is configured to adjust the operations of the monitoring device 12 to control the amount of the electrical energy that is consumed by the monitoring device 12 as a result of the monitoring of the environment about the monitoring device 12 in some of the embodiments discussed herein. In one embodiment, the microcontroller can increase or decrease an amount of electrical energy provided to the inductive drive coil 50 to control the amount of electrical energy that is consumed. In one embodiment, the salinity sensor may be de-activated for a period of time where no electrical energy is provided to coil 50.

Referring to FIG. 7, the microcontroller 58 may monitor the voltage of the capacitor 70 and increases and decreases in the capacitor voltage are monitored by the microcontroller 58 and the salinity of the water can thus be determined through calibration. Each of the measurements of the capacitor voltage can be performed in a couple of milliseconds by the microcontroller 58. If the voltage of the capacitor 70 shows a consistently and distinctly higher or lower value than the previous readings, it can be concluded that the salinity of the water in the aquatic environment of the organism being monitored has changed. For example, a higher capacitor voltage reading indicates that the monitored organism may have entered an estuary. In some embodiments, one or more thresholds of corresponding output voltages of the capacitor 70 may be used to monitor different salinity levels of the water of the aquatic environment of the organism.

Accordingly, the inclusion of the salinity sensor 57 enables the monitoring device 12 to become aware of its surrounding aquatic environment (i.e., freshwater vs. sea water). The different salinity in the water may be used to trigger an action of the tag such as controlling the amount of electrical energy that is consumed by the device 12. Example actions that may be triggered and performed by the monitoring device 12 include putting itself into a hibernation state to conserve battery energy when the organism enters the ocean, or waking itself back up from the hibernation state to enable transmission as the organism returns from the ocean to freshwater.

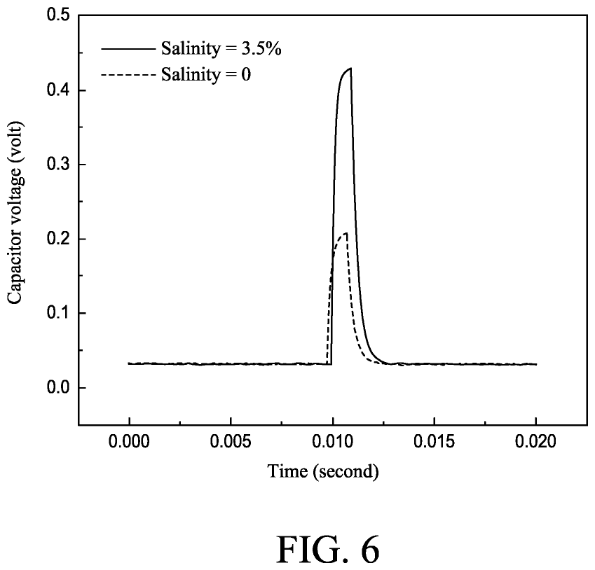

Referring to FIG. 6, a graphical representation of the voltage of the capacitor 70 of the sensor circuitry 49 is shown corresponding to water having different salinities. As shown, emersion of the sensor 57 in water having 3.5% salinity results in an increased voltage of approximately 0.44 Volts compared with approximately 0.2 Volts in fresh water of 0% salinity. The detection of a change in the voltage is used to control the amount of electrical energy consumed by the monitoring device 12 in one embodiment, for example by controlling one or more circuit component to enter a different state of increased or decreased power consumption.

In some embodiments mentioned above, the microcontroller 58 can control the amount of electrical energy consumed by the monitoring device 12 from its battery 42 as a result of the detection of electromagnetic energy or a change in salinity of the water of the environment of the monitoring device. In some example embodiments, the microcontroller 58 may control an amount of the electrical energy from the battery that is consumed by at least one of the circuit components of the monitoring device 12.

In a more specific example, the microcontroller 58 may control one or both of the resonator 56 and dual analog switch 60 to consume more or less electrical energy, for example by powering-up or down the respective component. In addition, the microcontroller 58 itself may change its operational mode to one of increased or decreased electrical energy consumption.

In another example, the microcontroller 58 adjusts the ping rate of emissions of the wireless signals from the monitoring device 12 to adjust the amount of electrical energy of the battery that is consumed. In some implementations, a 2, 3 or 5 second ping rate is used at an initial moment in time, and thereafter, the ping rate may be increased to 10-60 seconds to consume less electrical energy and prolong the life of the monitoring device. In one embodiment, the microcontroller 58 controls the dual analog switch 60 to generate the wireless signals from the monitoring device 12 in accordance with the selected ping rate.

As mentioned above, it is not necessary to have a monitoring device continuously transmit signals until its battery is completely drained for many organism-tracking applications. For example, for dam passage studies involving multiple dams, users are typically only interested in the fish's passage behavior and survival near the dams but not in the long river sections between them where there are no receivers to receive the transmissions. In addition, because of the limited transmission range of the monitoring devices (e.g., <500 m), the usefulness of the monitoring device is also limited by the coverage area of the detection devices deployed. The transmissions made by the monitoring device when the fish travels through areas where there is no detection equipment coverage are essentially useless and a waste of the electrical energy of the battery of the monitoring device.

Some of the monitoring devices disclosed herein are aware or conscious of their current locations or environments (e.g. located at a dam, in ocean or a river) and can intelligently manage its own operation (and power consumption) accordingly and provide increased efficiency in use of the electrical energy from the battery. These monitoring devices greatly enhance the capabilities of Juvenile Salmon Acoustic Telemetry System (JSATS) systems or other acoustic telemetry-based fish tracking systems by: (1) significantly extending the monitoring period for both anadromous and catadromous aquatic species, which could be up to their entire life cycles; and (2) introducing the quasi-location-aware functionality to the monitoring devices.

The JSATS employs acoustic transmitters and receiving systems to remotely track fish in one, two, or three dimensions with sub-meter accuracy. Monitoring devices described herein are useable in JSATS systems and are small enough for use in monitoring the smallest migratory individuals of the juvenile Chinook salmon and steelhead populations of the Columbia River basin. The monitoring devices may be used to monitor the behavior, movement, habitat use, and survival of juvenile salmonids migrating from freshwater (through rivers, reservoirs, and past hydroelectric dams) into saltwater. The monitoring devices may be used to monitor the movements of many other species such as European eel, sea trout, channel catfish, smallmouth bass, northern pikeminnow, walleye, lamprey, and sturgeon, and fish behavior in relation to a variety of waterpower structures and in many other geographic locations including the Pacific Northwest of the United States, California, Australia and Brazil.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended aspects appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

What is claimed is:

1. An organism monitoring device configured to be associated with an organism to be monitored, the organism monitoring device comprising:
a housing;
a battery coupled with the housing, wherein the battery is configured to store electrical energy;
a transmitter coupled with the housing and the battery, wherein the transmitter is configured to emit a wireless signal externally of the organism monitoring device and the organism being monitored;
sensor circuitry coupled with the housing and the battery, wherein the sensor circuitry is configured to monitor an environment of the organism monitoring device; and
control circuitry coupled with the housing, the sensor circuitry and the battery, and wherein the control circuitry is configured to adjust an operation of the organism monitoring device as a result of monitoring of the environment of the organism monitoring device by the sensor circuitry.

2. The device of claim 1 wherein the transmitter is configured to emit the wireless signal including a first code at a first moment in time, wherein the control circuitry is configured to adjust the operation comprising controlling the transmitter to emit the wireless signal comprising a second code at a second moment in time, and wherein the first and second codes are different.

3. The device of claim 2 wherein the sensor circuitry is configured to monitor for a presence of electromagnetic energy within the environment, and wherein the control circuitry is configured to adjust the operation as a result of the sensor circuitry detecting the presence of the electromagnetic energy.

4. The device of claim 2 wherein the environment is an aquatic environment, wherein the sensor circuitry is configured to monitor salinity of the aquatic environment, and wherein the control circuitry is configured to adjust the operation as a result of the monitoring of the salinity of the aquatic environment.

5. The device of claim 1 wherein the control circuitry is configured to adjust the operation of the organism monitoring device that results in an adjustment of an amount of the electrical energy from the battery that is consumed by the organism monitoring device as a result of the monitoring by the sensor circuitry.

6. The device of claim 5 wherein the sensor circuitry is configured to monitor for a presence of electromagnetic energy within the environment, and wherein the control circuitry is configured to adjust the operation as a result of the sensor circuitry detecting the presence of the electromagnetic energy.

7. The device of claim 6 wherein the control circuitry is configured to adjust the operation as the result of the control circuitry detecting a code in the electromagnetic energy.

8. The device of claim 6 wherein the sensor circuitry comprises an inductive coil that is configured to generate a current in the presence of the electromagnetic energy, and wherein the control circuitry is configured to adjust the operation as a result of the current.

9. The device of claim 8 wherein the inductive coil is a first inductive coil and the current is a first current, wherein the control circuitry is configured to control the application of electrical energy to a second inductive coil that is configured to induce a magnetic field, wherein the first coil is configured to generate a second current as a result of the induced magnetic field, and wherein the control circuitry is configured to adjust the operation as a result of the second current.

10. The device of claim 5 wherein the adjustment of the amount of the electrical energy from the battery that is consumed is an increase in the amount of the electrical energy.

11. The device of claim 5 wherein the adjustment of the amount of the electrical energy from the battery that is consumed is a decrease in the amount of the electrical energy.

12. The device of claim 5 wherein the organism monitoring device comprises a plurality of components and the control circuitry is configured to adjust the operation comprising controlling an amount of the electrical energy from the battery that is consumed by at least one of the components.

13. The device of claim 12 wherein one of the components comprises a resonator configured to generate a clock signal to control timing of the organism monitoring device, and wherein the control circuitry is configured to control an amount of the electrical energy that is consumed by the resonator to adjust the operation.

14. The device of claim 1 wherein the transmitter is configured to periodically emit the wireless signal according to a first ping rate, wherein the control circuitry is configured to adjust the operation comprising controlling the transmitter to periodically emit the wireless signal according to a second ping rate, and wherein the first and second ping rates are different.

15. The device of claim 1 wherein the environment is an aquatic environment and the sensor circuitry is configured to monitor salinity of the aquatic environment, and the control circuitry is configured to adjust the operation as a result of the monitoring of the salinity of the aquatic environment.

16. The device of claim 15 wherein the sensor circuitry is configured to monitor for a presence of electromagnetic energy within the environment, and the control circuitry is configured to adjust another operation of the organism monitoring device as a result of the sensor circuitry detecting the presence of electromagnetic energy.

17. The device of claim 15 wherein the sensor circuitry comprises plural inductive coils that are configured to generate a current that is proportional to the salinity of the aquatic environment.

18. The device of claim 1 wherein the sensor circuitry comprises a salinity sensor, and wherein the control circuitry is configured to adjust the operation including adjusting an amount of the electrical energy that is applied to the salinity sensor as a result of the monitoring of the environment.

19. The device of claim 1 wherein the transmitter is configured to emit the wireless signal comprising an acoustic signal in the environment comprising an aquatic environment.

20. The device of claim 1 wherein the control circuitry is configured to enter a second state of increased power consumption from a first state of reduced power consumption to process outputs of the sensor circuitry as a result of receipt of an interrupt from the sensor circuitry by the control circuitry.

21. The device of claim 1 wherein the organism monitoring device has a dry weight of 0.84 grams or less.

22. An organism monitoring method comprising:
associating an organism monitoring device with an aquatic organism to be monitored;
after the associating, emitting an acoustic signal from the organism monitoring device into an aquatic environment about the aquatic organism;
monitoring the aquatic environment about the aquatic organism; and
adjusting an operation of the organism monitoring device as a result of the monitoring.

23. The method of claim 22 wherein the adjusting comprises adjusting an amount of electrical energy that is consumed by the organism monitoring device as a result of the monitoring.

24. The method of claim 22 wherein the monitoring comprises monitoring for a presence of electromagnetic energy within the aquatic environment about the aquatic organism.

25. The method of claim 22 wherein the monitoring comprises monitoring salinity of water of the aquatic environment.

26. The method of claim 22 wherein the monitoring comprises monitoring for a presence of electromagnetic energy within the aquatic environment about the aquatic organism and monitoring salinity of water of the aquatic environment.
